(19) United States
(12) Patent Application Publication
(10) Pub. No.: US 2007/0245894 A1
(43) Pub. Date: Oct. 25, 2007

(54) Vapor & moisture resistant conduit

(76) Inventor: David Poulis, Santa Maria, CA (US)

Correspondence Address: LAW OFFICES OF ANDREW Y. SCHROEDER, 500 SOUTH BROADWAY, SUITE 222, SANTA MARIA, CA, 93454, US

(21) Appl. No.: 11/409,357

(22) Filed: Apr. 20, 2006

(51) Int. Cl. B01D 53/22

(52) U.S. Cl. 96/4

(57) ABSTRACT

A membrane resistant conduit for the purpose of preventing moisture and/or vapor migration comprising: a membrane sheet and a channel, the channel comprising a first member and a second member, the membrane sheet having a top side and a bottom side.

### FIELD OF THE INVENTION

The present invention relates to the construction industry and more particularly relates with an apparatus for use in the construction of buildings, homes and other structures.

### BACKGROUND OF THE INVENTION

Per current Building Codes and ASTM (American Society for Testing Materials) strict rules are in place which promulgate the use of vapor membranes to be used in construction projects. The aim of these codes, specifications and laws is to reduce the amount of moisture and radon migration into buildings, dwellings and other structures. By observing these codes one can eliminate many drastic problems frequented in the construction industry.

One of the main problems with building a solid foundation for a home or a building is how to prevent moisture from permeating through the concrete foundation. The main source of moisture migration is from the groundwater underneath the structure (the other main source is through roofing). Studies show that 80% of the moisture in a building originates from building site groundwater. If groundwater or other moisture permeates through the concrete serious damage may ensue. Each year in the United States over $1.8 Billion dollars worth of damage results from moisture migration and its effects on floor coverings, adhesives, and coatings systems. What's more, many of these effects may not manifest themselves for months or years.

Moisture migration occurs through two ways: capillary action and vapor from underneath the slab. Capillary action occurs through surface tension and the general dynamic of diffusion. Vapor migration occurs due to the humidity of the soil. Oftentimes, soil tested near the slabs can exhibit a humidity approximating 100%.

Another problem with moisture migration is its affect on air quality inside the structures such as buildings and homes. When excess moisture is able to permeate through the ground threshold, the excess moisture facilitates the rapid propagation of mold, mildew, spores, bacteria and other pathogens.

Another problem associated with moisture migration is the relative acidity or alkalinity of the moisture itself. Many tests performed in moisture migrations have found pH levels in the range of 11-12 (7 being neutral such as water and 14 being maximum alkalinity. This heightened alkalinity can lead to failure or disbondment of the flooring system, especially when the adhesives is coupled with a re-emulsification of the adhesive.

Yet another related issue, albeit a lesser issue is radon permeation through the ground threshold. Without an effective membrane under a concrete foundation, excess radon may also permeate the ground threshold causing various health maladies. Excess radon permeation has been linked with cancer.

Unfortunately, the marketplace has yet to adequately provide a means of completely stopping moisture migration and/or radon migration. Currently, materials known as vapor membrane or retarder are used to prevent sub-slab moisture migration. These materials are typically made from low-permeance polyethylene or polyolefin membranes. Although these materials are effective in preventing moisture migration, problems develop when conduits must be made through the slab and vapor membrane or retarder. When vapor membrane must be compromised in order to receive conduit for pipes or electrical wires it is difficult to completely repair the vapor membrane such that moisture migration will not inexorably ensue around the compromised seams.

According to ASTM E 1643 it is required that all damaged areas of vapor barrier be lapped with a minimum of 6″ of vapor barrier and sealant materials. Or, in the alternative ASTM E 1745-97 promulgates that the producer shall provide instructions for lap sealing, including minimum width of lap, method of sealing, and either supply or specify suitable products for lap sealing.

Stego®, one of the leaders of vapor barriers, directs in its guidelines to construct pipe boots from vapor barrier material, pressure sensitive tape and/or mastic where pipes or other conduits traverse the vapor barrier. At these points of compromise awkward boots are formed using membrane, mastic, and tape around the conduit area. In particular, they admonish that “all patches must cover damaged area by 6″ on all sides”.

Unfortunately, it is very difficult to comply with these requirements at points of compromise where structures must traverse a vapor barrier, specifically the requirement for a 6″ overlap. Typically the vapor barrier is used to boot around all penetrations and seal with tape to create a continuous vapor barrier. However, it may not always be possible to create a seal which accords with general codes and standards where a pipe must traverse a vapor barrier from underneath a slab. The reason for this is because of the awkward processes used to make this pipe boot due to the procedures which include several cuts of membranes overlapping, taping, and mastic.

Moreover, the use of sealing materials such as tape and mastic are not expedient for the use of repairing vapor barrier. Both of the adhesives which are used with tape and mastic are biodegradable and may corrode over time. Mastic is particularly susceptible to high metabolic rate bacteria which can decompose the material.

Another problem with the biodegradable adhesives is the fact that the amount of water available to the bacteria increases at the point of compromise. This natural reservoir of water results in a proliferation of bacteria at the seams. As a result, the bacteria may corrode the tape and mastic precisely at the point where the vapor barrier or retarder is weakest.

When sealants such as tape and mastic give way to bacteria these points of compromise can yield large amounts of moisture migration. Studies show that even a ⅛″ diameter orifice in a vapor barrier can cause moisture filtration at a rate of 1.3 lbs/1,000 sf injust 24 hours.

Therefore, what is clearly needed in the art is an apparatus which repairs the vapor membrane or retarder at the points of compromise as well as other materials which repel moisture at their respective points of compromise. Examples of these points of compromise can be found where pipes must traverse a concrete slab from underneath, conduits in roofs (e.g. sky lights, solar panel wiring, vents), retaining wall conduits, sidewall structures, and re-models.

### SUMMARY OF THE INVENTION

It is an object of the present invention to prevent moisture migration and radon migration by repairing the compromised areas of membranes such as vapor membrane or retarder where conduits are necessary. This repair will be in compliance with most applicable standards per the ASTM as well as other applicable building codes. Said apparatus possesses a seal and enables conduits to pass through the points of compromised membrane or retarder without infiltration of vapor or moisture. These conduits are typically used for enabling the passage of pipes or electrical wires. Said conduits may be formed at: concrete slabs from underneath, conduits in roofs (e.g. sky lights, solar panel wiring, vents), retaining wall conduits, sidewall structures, and re-models.

### BRIEF DESCRIPTION OF THE DRAWING FIGURES

FIG. 1 is a perspective view of a preferred embodiment of the present invention.

FIG. 2 is an perspective view of a preferred embodiment of the present invention.

FIG. 3 is a cross-sectional view of a preferred embodiment of the present invention

FIG. 4 is an plan view of a preferred embodiment of the present invention.

FIG. 5 is an exploded view of a preferred embodiment of the present invention

FIG. 6 is a cross-sectional view of a preferred embodiment of the present invention

FIG. 7 is a plan view of a preferred embodiment of the present invention

FIG. 8 is an exploded view of a preferred embodiment of the present invention.

### DESCRIPTION OF PREFERRED EMBODIMENTS

According to a preferred embodiment of the present invention, a unique apparatus is used to repair the compromised areas of the membrane sheets used for the purpose of preventing moisture migration and/or radon migration. The present invention is described in enabling detail below.

It will be pointed out here that the present invention is designed to act as a water tight, water impermeable conduit for pipes, electrical wires or any other object which must breach the vapor membrane or retarder. For this reason, the present invention is used primarily at points of compromise where conduits for pipes, electrical wires are needed. In addition, when conduits in roofs (e.g. sky lights, solar panel wiring, vents), retaining walls, sidewall structures, re-models, and concrete slabs are needed the present invention is also applicable.

It should first be noted that the present invention incorporates and refers to applicable current codes, rules, standards and specifications While some of these rules may change in time, the present invention intends to be applicable and incorporate the aforementioned rules notwithstanding future changes.

Certain terms of interest are noted here and are defined. According to the American Concrete Institute (ACI 302.1 R-96) “a VAPOR RETARDER is a material with a perm rating less than 0.3 perms for sub-slab conduits. A VAPOR BARRIER is a material with a perm rating of 0.3 perms or greater. The American Society for Testing Materials (ASTM) says that the terms vapor retarder and vapor barrier are “interchangeable”. Accordingly, for the purposes of the present invention, the terms vapor barrier and vapor retarder will be used interchangeably. Moreover, the term “membrane” shall encompass a broader subset of these sheets.

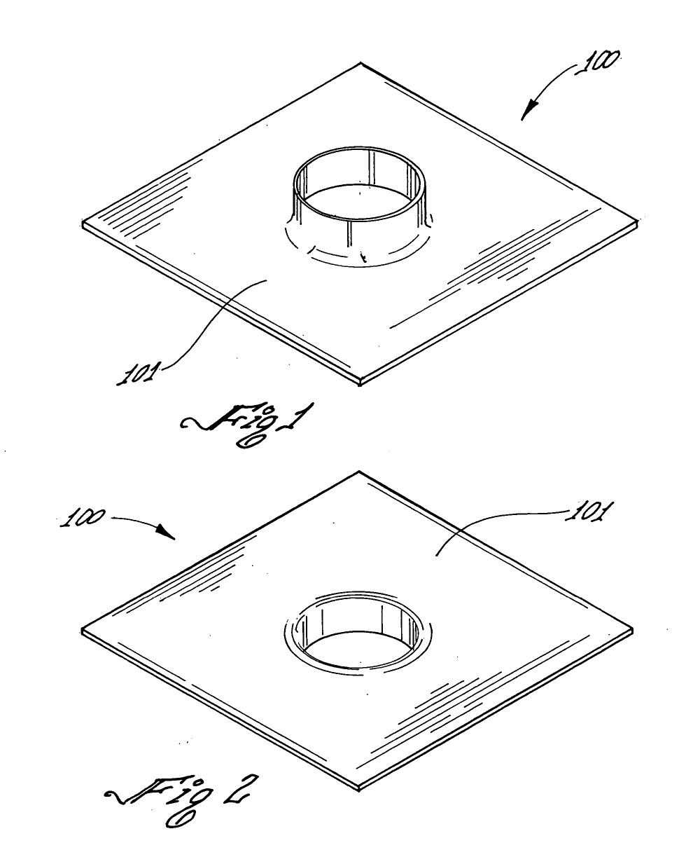

FIG. 1 illustrates a preferred embodiment of the present invention. Membrane resistant conduit 100 is comprised of a membrane sheet 101. The hole in the center acts as an orifice for allowing a conduit (which may house pipes, electrical wires, etc.). Moreover, Membrane resistant conduit 100 is comprised of two regions: the repellant side which is illustrated in FIG. 2 and the moisture side which is illustrated in FIG. 1.

It should be noted here that although Membrane resistant conduit 100 is described as being comprised of two different regions, it should not be construed as being constructed of 2 or more separate parts. In some embodiments, the Membrane resistant conduit 100 may be comprised of only one part. For this reason the terms “repellant side”, and “moisture side” may be more aptly described as a demarcation between the two planes above and below the membrane rather than being two or more separate parts.

Membrane sheet 101 is comprised of material well known in the art as vapor membrane or vapor retarder. Other types of membranes which may also be used for the purpose of preventing moisture migration and/or radon migration are: Stego® Wrap (a Trademarked material), Moistop® (a Trademarked material), Visqueen® (a Trademarked material) Pandex® (a Trademarked material), Vaporblock® (a Trademarked material. Most membrane sheets 101 are comprised of either polyethylene or polyolefin materials. These materials are used because they may possess the requisite tensile strength along with the low permeance in order to prevent moisture migration as well as radon migration.

As per ASTM E 1745-97 “Plastic Vapor Barriers”, the membranes of Class A are the most stringent with respect to parameters such as tensile strength, perms, etc. For this reason, it is preferable to use the membranes manufactured by Stego®. Stego® is the only known membrane manufacturer which meets and exceeds all parameters set forth in class A according to Stego® per testing performed by independent testing laboratories.

Examples of expedient materials which may be used as membranes for the purposes of the present invention include, but are not limited to: low density polyethylene (LDPE) membranes, Composite LDPE and asphalt coated kraft paper membranes, “State of the Art” LDPE membranes (includes polyolefin), cross-laminated LDPE membranes, High density polyethylene (HDPE) membranes, fiber reinforced composite LDPE membranes, and multiply bituminous membranes. Various roofing, siding, and insulating membranes may also be incorporated for use with the present invention. Since there abound a panoply of different membrane sheets which are designed for different uses and purposes (some may be designed for certain types of grade, construction, alkalinity levels, radon retardants, etc.) the specific type of membrane sheet is of no consequence insofar as it meets minimum standards set forth by the governing construction laws and regulations.

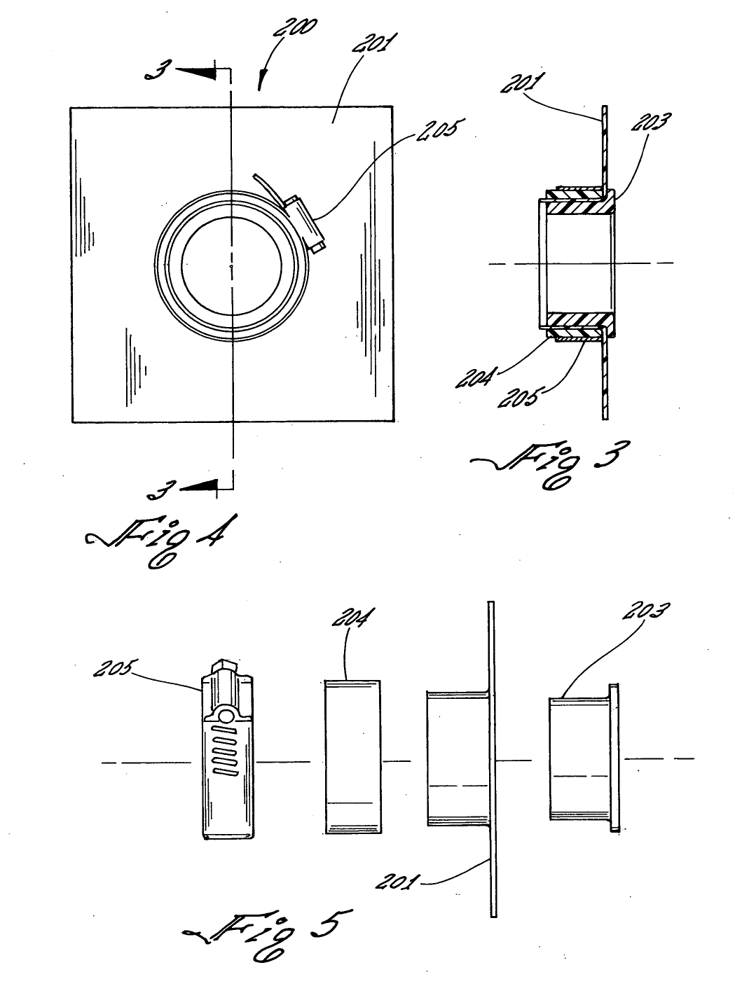

FIGS. 3-5 illustrate another preferred embodiment of the present invention. Membrane resistant channel 200 comprises a membrane 201, a repellant member 203, a moisture member 204, and a clamp 205. The combination of both the repellant member and the moisture member will be referred to hereafter as the channel. For purposes of clarity repellant member 203 refers to the member which faces upwards whereas the moisture member 204 refers to the member which is facing downwards. The conduit refers to the apparatus which will be inserted through the present invention. In addition, in some preferred embodiments a clamp 205 may also be incorporated.

Additionally, it should be pointed out here that although in some cases the membrane sheet may require an orifice to assemble the present invention, in some preferred embodiments, the membrane sheet may be molded with the channel as a one piece unit. For this reason, the scope of the present invention shall include both assembled embodiments, and molded one-piece embodiments.

FIG. 5 illustrates an exploded view of the present invention. In some embodiments the membrane sheet is punctured in such a way in order to receive the repellant member 203 and the moisture member 204. In this particular embodiment, a hole is made to create an opening for the members.

FIG. 5 also illustrates how the repellant member and the moisture member are sized to fit and cooperate with each other in order to prevent moisture migration. In this preferred embodiment, either the repellant member or the moisture member is made of a pliable rubber material, whereas the other member is comprised of a plastic or other hard material such as PVC. Rubber is an expedient material for this purpose because it can be assembled in such a way as to create a very tight interference fit without the use of glue, tape, or other adhesives. Moreover, combining rubber with plastic or PVC creates a water impermeable interference fit which is desirable in the present invention. Also, it should be pointed out here that both repellant member and moisture member are sized to fit each other.

It should also be pointed out here that where channel is comprised of two or more parts, the parts may be joined independently by either threading or tapping, heat welding, glue, etc. Furthermore, in some preferred embodiments the interference fit may not need to be facilitated by anything at all except the sizing of the respective parts. The possibilities are endless.

It is of no consequence what types of material or types of pieces are used to comprise either the moisture member or the repellant member. There abound a panoply of different pieces and materials which may prove to be equally expedient for the stated purposes of the present invention. For this reason, the types of materials or other components should not be construed to be limiting the scope of the present invention.

The clamp 205 is also used in order to facilitate a tight interference fit. It may not be necessary to use a clamp 205 in all embodiments of the present invention. Oftentimes, the interference fit between the repellant member and the moisture member will be so strong that the clamp 205 may not be necessary.

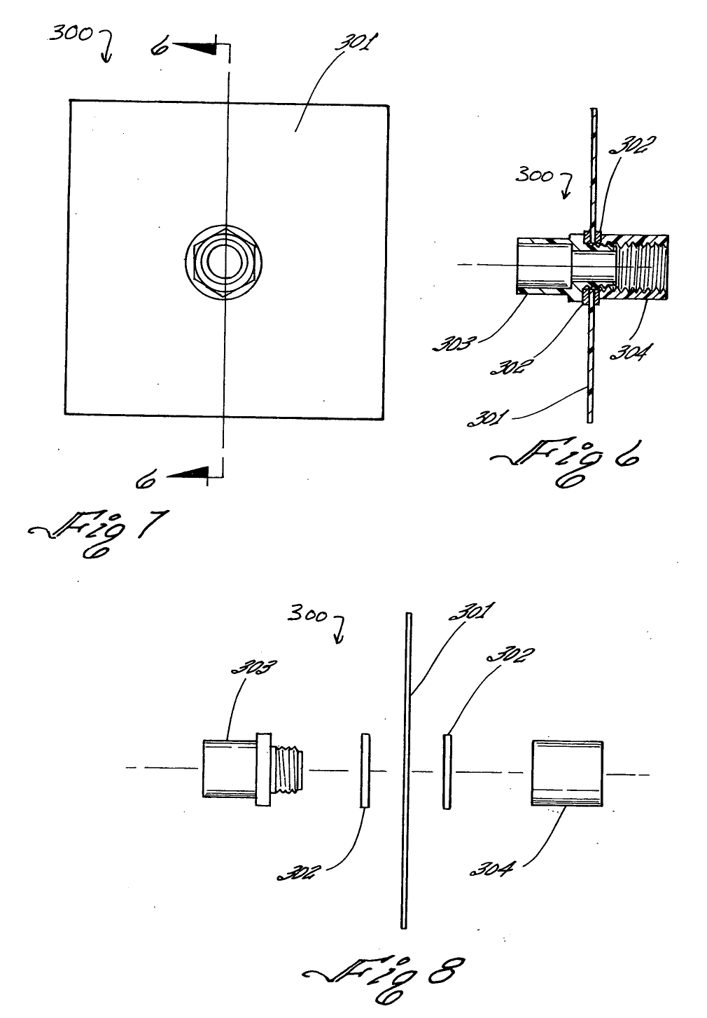

FIGS. 6-8 illustrates another embodiment of the present invention. Membrane PVC conduit 300 comprises a membrane sheet 301, a top member 303, a bottom member 304 and rubber washers 302. Membrane PVC conduit 300 is assembled in the same fashion as the previous embodiment except that both the top member 303 and the bottom member 304 are complementarily threaded in order to mate with each other. In order to further facilitate a water-tight seal, rubber washers are also placed on both sides of the membrane sheet so they are sandwiched by the opposing members. FIG. 8 illustrates the exploded view by which it is assembled in the same fashion as the previous embodiment.

The type of mating members used whether it be PVC or other is not to be construed as limiting to the present invention. And also the method of mating the respective members is of no consequence insofar as it creates a water tight interference fit which accords with the stated objectives of the present invention. There abound a panoply of different parts or materials which may be used which are all equally expedient.

It will be apparent to the skilled artisan that there are numerous changes that may be made in embodiments described herein without departing from the spirit and scope of the invention. For example, various types of materials such as copper, alunimum, etc. may comprise some of the elements of the present invention. Or, in some other preferred embodiments, mating members may be alternatively, tapped, threaded, glued, compressed, etc. in order to create the interference fit. Also, various different types of washers abound which may also be used in accordance with the present invention. The possibilities are endless. As such, the invention taught herein by specific examples is limited only by the scope of the claims that follow.

What is claimed is:

1. A membrane resistant conduit for the purpose of preventing or repelling moisture and/or vapor migration comprising: a membrane sheet, the membrane sheet comprising a repellant side, a moisture side and an orifice.

2. The membrane resistant conduit of claim 1 further comprising a channel, the channel is comprised of a first member and a second member, the channel is positioned around the orifice.

3. The membrane resistant conduit of claim one wherein the first member is made of rubber and the second member is made of a hard material.

4. The membrane resistant conduit of claim 1 wherein the membrane sheet is composed of polyethylene.

5. The membrane resistant conduit of claim 1 wherein the membrane sheet is composed of polyolefin.

6. The membrane resistant conduit of claim 3 further comprising a clamp, the clamp being placed over the second member.

7. The membrane resistant conduit of claim 2 further comprising a clamp, the clamp to be removably placed upon the channel.

8. The membrane resistant conduit of claim 6 wherein the membrane sheet is thicker than 10 mils.

9. The membrane resistant conduit of claim 1 wherein the first member and the second member is composed of PVC.

10. The membrane resistant conduit of claim 1 wherein the membrane sheet is composed of a material with a permeance of less than 0.3 perm.

11. The membrane resistant conduit of claim 1 wherein the membrane sheet has a length between the channel and the nearest edge which exceeds 2 inches.

12. A membrane resistant conduit for the purpose of preventing moisture migration comprising: a membrane sheet, a first member and a second member, a first washer and a second washer, the membrane sheet having a top side and a bottom side, the membrane sheet possessing an orifice near the center, the first member passing through the bottom side and interfacing with the second mating member on the top side, the first washer being sandwiched between the membrane sheet and the first member and the second washer being sandwiched between the membrane sheet and the second member.

13. The membrane resistant conduit of claim 11 wherein the first member and the second member are complementarily threaded and sized to mate with each other.

14. The membrane resistant conduit of claim 11 wherein the first member and the second member are tapped and are sized to fit each other.

15. The membrane resistant conduit of claim 11 wherein the first washer and the second washer is made of rubber.

16. The membrane resistant conduit of claim 11 wherein the membrane sheet is composed of polyethylene.

17. The membrane resistant conduit of claim 11 wherein the membrane sheet is composed of polyolefin.

18. The membrane resistant conduit of claim 16 wherein the membrane sheet is thicker than 10 mils.

19. The membrane resistant conduit of claim 17 wherein the membrane sheet has a length between the inside surface of the second region and the nearest edge which exceeds 5 inches.

20. A membrane resistant conduit for the purpose of preventing moisture migration comprising: a membrane sheet and a conduit, the membrane sheet is comprised of a top side and a bottom side, the membrane sheet is composed of polyethylene with a thickness greater than 10 mils and a permeance less than 0.3 perm,
